(19) United States
(12) Patent Application Publication
(10) Pub. No.: US 2026/0197367 A1
(43) Pub. Date: Jul. 9, 2026

(54) SYSTEMS AND METHODS FOR USE OF A VEHICLE AS AN EDGE SERVER

(71) Applicant: Ford Global Technologies, LLC, Dearborn, MI (US)

(72) Inventors: Rodrigo Tellez, Tlalnepantla de Baz (MX); ABRAHAM VALLADOLID MARTINEZ, Benito Juarez (MX); Rebeca Selene Hernandez, Nezahualcoyotl (MX); Bren Lizette Lopez, Ocoyoacac (MX); Marco Antonio Lozano, Gustavo A Madero (MX)

(73) Assignee: Ford Global Technologies, LLC, Dearborn, MI (US)

(21) Appl. No.: 19/013,213

(22) Filed: Jan. 8, 2025

(51) Int. Cl. H04L 67/12

(52) U.S. Cl. CPC H04L 67/12

(57) ABSTRACT

Systems and methods for using vehicles as mobile edge servers are provided. A vehicle may be programmed with specialized instructions enabling the vehicle to act as an edge server. A user may enable an edge server mode on the vehicle once the vehicle is parked or otherwise idle. A control server may receive a request from a user device for delivery of content. The control server may then choose a vehicle with a lowest latency to the user device based on the user device location, the vehicle location, the edge server mode being enabled on the vehicle. The control server may cause the chosen vehicle to provide the content to the user device. If the chosen vehicle does not have the requested content, the control server may fetch the content and provide that to the chosen vehicle.

### FIELD

The present disclosure relates to the field of content delivery networks. Specifically, embodiments of the present disclosure relate to systems and methods related to the use of vehicles to provide content delivery services.

### BACKGROUND

A Content Delivery Network (CDN) is a distributed network of servers that work together to deliver content (such as websites, videos, images, and other digital assets) to end-users in a faster and more efficient way. CDNs utilize edge servers to reduce latency, enhance availability, and the overall user experience by caching and serving content closer to the user's geographical location.

When a user requests content (e.g., a webpage or video), the request is routed to the nearest edge server. The edge server checks if it has a cached version of the requested content. If the content is cached and current, the edge server provides the content directly to the user. If the content is not cached or is outdated, the edge server fetches the content from the origin server or another edge server, updates its cache, and then serves the content to the user. Future requests for the same content are served from the edge server's cache, ensuring faster response times.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an environment in which embodiments of the present disclosure can be implemented.

FIG. 2 illustrates a block diagram of a vehicle according to an embodiment of the present disclosure.

FIG. 3 illustrates a high-level functional diagram of a system that can provide content delivery services according to an embodiment of the present disclosure.

FIGS. 4A and 4B illustrate example user interface screens of the user device according to an embodiment of the present disclosure.

FIG. 5 illustrates a flow chart for a process for providing content to one or more end users according to another embodiment of the present disclosure.

FIG. 6 illustrates a flow chart of a process for providing content to a user device according to an embodiment of the present disclosure.

FIG. 7 illustrates a flow chart of a process according to an embodiment of the present disclosure.

FIG. 8 illustrates a block diagram of a server according to an embodiment of the present disclosure.

### DETAILED DESCRIPTION

### Overview

The present disclosure describes systems and methods for using vehicles as mobile edge servers as part of a content delivery service/network.

Embodiments of the present disclosure provide methods of using a vehicle as an edge server in a content delivery network. The methods may include a central server receiving a request from a user device that includes information about a content item. The methods may further include the server determining a first location of the user device. Thereafter, the methods may include the server determining one or more vehicles located in a vicinity of the first location and that the one or more vehicles are currently parked. The methods may further include the server determining that an edge server mode is enabled on the one or more vehicles. Thereafter, the methods may include the server determining a first vehicle from the one or more vehicles that has a lowest latency to the user device and instructing the first vehicle to provide the content item to the user device.

In another instance, a control server includes one or more processors, a memory device coupled to the one or more processors, and a communication interface coupled to the one or more processors. The control server may receive a request from a user device that includes information about a content item. The control server may determine a first location of the user device, and one or more vehicles located in a vicinity of the first location. The control server may then determine that the one or more vehicles are currently parked and that an edge server mode is enabled on the one or more vehicles. The control server may then determine a first vehicle from the one or more vehicles that has a lowest latency to the user device and instruct the first vehicle to provide the content item to the user device.

In yet another instance, a method is provided in which a central/control server determines a location and time of an event, determines that a density of edge servers at the location is lower than a threshold, and, based on that, causes a plurality of autonomous vehicles to travel to the location and park in a vicinity of the location. The control server then enables an edge server mode on each of the plurality of autonomous vehicles. The control server further causes content related to the event to be stored in a local memory of each of the plurality of autonomous vehicles. The control server then receives requests from a plurality of user devices to access the content related to the event and causes the plurality of autonomous vehicles to provide the content related to the event to the plurality of user devices.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

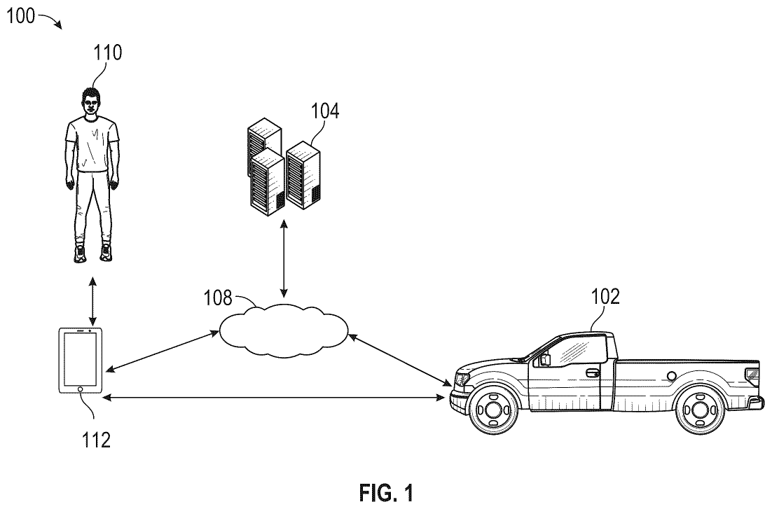

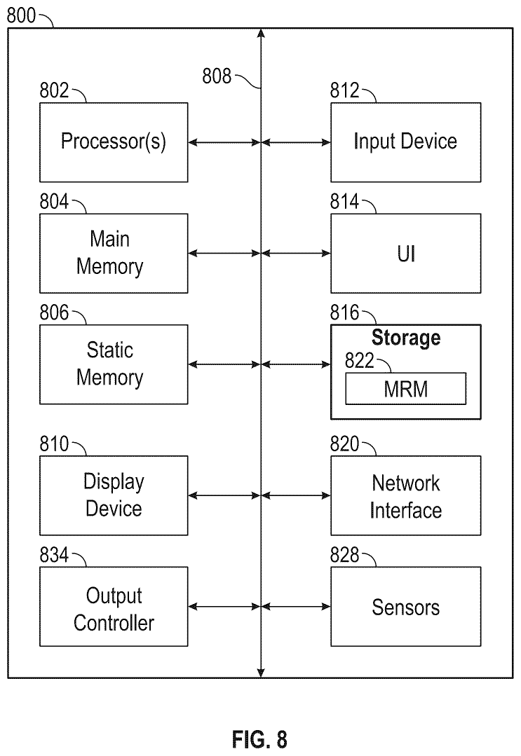

FIG. 1 illustrates an environment 100 in which the embodiments of the present disclosure may be implemented. The vehicle 102 can be any passenger or commercial vehicle such as a car, truck, tanker, bus, or the like. The environment 100 may also include a control server 104. The control server 104 may be part of a cloud-based computing infrastructure and may be associated with and/or include a Telematics Service Delivery Network (SDN) that provides digital data services to the vehicle 102. In another embodiment, the control server 104 may act as a hub server that provides content delivery services in conjunction with the vehicle 102. Details of the control server 104 are provided below with reference to FIG. 8.

The environment 100 may also include a user device 112. The user device 112 may be one of a mobile phone, a tablet, a personal computer, a smart key fob, or the like. The user device 112 may be associated with a user 110 of the vehicle 102. The user 110 may be a driver of the vehicle 102 or a passenger in the vehicle 102. The user device 112 may receive information from the vehicle 102 and/or the control server 104. The user device 112 may have a specialized application installed on it that can interface with the vehicle 102 to download and display various types of vehicle-generated information and other control data. In one embodiment, the vehicle 102 may directly communicate with the user device 112 to send and receive data without the need for the network 108 and/or the server 104.

The environment 100 may further include a network 108. The network 108 illustrates an example communication infrastructure in which the connected devices discussed in various embodiments of this disclosure may communicate. The network 108 may be and/or include the Internet, a private network, public network, or other configuration that operates using any one or more known communication protocols such as, for example, transmission control protocol/Internet protocol (TCP/IP), Bluetooth®, Bluetooth® Low Energy (BLE), Wi-Fi based on the Institute of Electrical and Electronics Engineers (IEEE) standard 802.11, Ultra-Wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

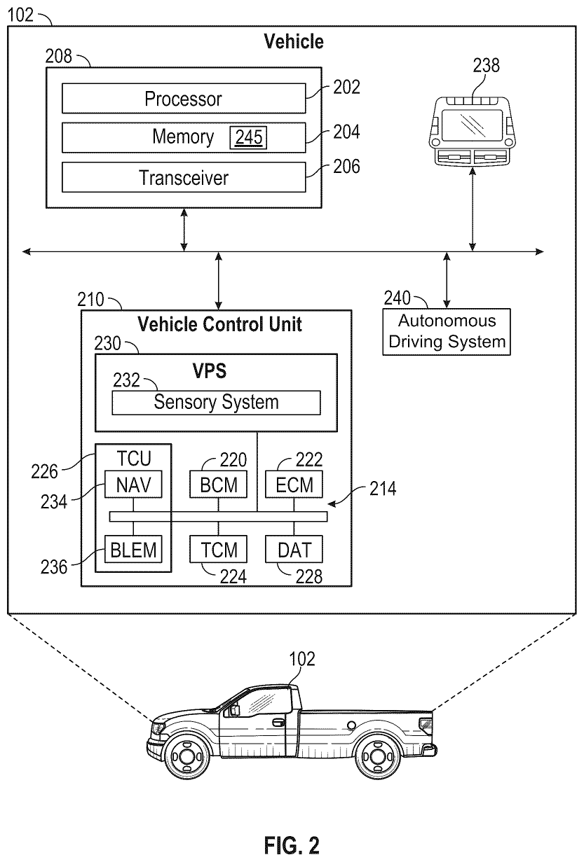

The vehicle 102 may include a plurality of units including, but not limited to, an automotive computer, a Vehicle Control Unit (VCU), and a detection unit. Details of the vehicle 102 are provided below in reference to FIG. 2.

FIG. 2 illustrates a block diagram of the vehicle 102 in which embodiments of the present disclosure can be implemented. The vehicle 102 may include a plurality of units including, but not limited to, an automotive computer 208, a Vehicle Control Unit (VCU) 210, and an infotainment unit 238. The VCU 210 may include a plurality of Electronic Control Units (ECUs) 214 in communication with the automotive computer 208.

In some embodiments, a user device, such as a mobile phone, a laptop computer, a smart fob, or the like, may be configured to connect with the automotive computer 208, which may communicate via one or more wireless connection(s), and/or may connect with the vehicle 102 directly by using near field communication (NFC) protocols, Bluetooth® protocols, Wi-Fi, Ultra-Wideband (UWB), and other possible data connection and sharing techniques.

The automotive computer 208 may be installed anywhere in the vehicle 102, in accordance with the disclosure. The automotive computer 208 may be or include an electronic vehicle controller, having one or more processor(s) 202, one or more memory devices 204, and one or more transceivers 206.

The processor(s) 202 may be in communication with one or more memory devices disposed in communication with the respective computing systems (e.g., the memory 204 and/or one or more external databases not shown in FIG. 2). The processor(s) 202 may utilize the memory 204 to store programs in code and/or to store data for performing operations in accordance with the disclosure. The memory 204 may be a non-transitory computer-readable storage medium or memory storing a vehicle control program code. The memory 204 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 204 may include a module 245 that can implement the various embodiments of the present disclosure. Module 245 may include instructions that can be executed by the processor 202 to realize the various embodiments of the present disclosure. For example, the module 245 may include custom algorithms or other software that allow the vehicle 102 to act as an edge server that can provide content delivery services to one or more user devices 112 that may be communicably coupled to the vehicle 102.

Automotive computer 208 may also include a transceiver 206. The transceiver 206 may be configured to receive information/inputs from one or more external devices or systems, e.g., a user device 208, an external server, and/or the like. Further, the transceiver 206 may transmit notifications, requests, signals, etc., to the external devices or systems. In addition, the transceiver 206 may be configured to receive information/inputs from vehicle components such as the vehicle sensory system 232, one or more ECUs 214, and/or the like. Further, the transceiver 206 may transmit signals (e.g., command signals) or notifications to the vehicle components such as the Body Control Module (BCM) 220, the infotainment system 238, and/or the like.

In some embodiments, the VCU 210 may share a power and/or communications bus with the automotive computer 208 and may be configured and/or programmed to coordinate the data between vehicle systems, connected servers, and/or the like. The VCU 210 may include or communicate with any combination of the ECUs 214, such as, for example, the BCM 220, an Engine Control Module (ECM) 222, a Transmission Control Module (TCM) 224, a Telematics Control Unit (TCU) 226, a Driver Assistance Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 232 may be coupled to the vehicle 102 at one or more locations and in one or more manner. For example, the various sensors of the vehicle sensory system 232 may be integrated into the various subsystems of the vehicle 102, such as doors, mirrors, roof, etc., or attached to the vehicle 102 using an appropriate mounting mechanism. In some embodiments, the various sensors of the vehicle sensory system 232 may be located at the front, back, sides, top, bottom, and underneath the vehicle 102. The location of a sensor may depend on its function. For example, a sensor that monitors the area underneath the vehicle may be connected to a bottom surface of the vehicle 102, while a sensor that can monitor an area to any side of the vehicle 102 may be mounted or integrated into the doors of the vehicle 102. Vehicle sensory system 232 may also include one or more road noise sensors, such as accelerometers, that are coupled to various mechanical components and/or systems of the vehicle 102. One skilled in the art will realize that the sensors may be coupled to the vehicles in various ways and locations other than the ones mentioned above.

In some embodiments, the VCU 210 may control vehicle operational aspects and implement one or more instruction sets received from the server 104, the user device 112, or from one or more instruction sets stored in the memory 204.

The TCU 226 may be configured and/or programmed to provide vehicle connectivity to wireless computing systems onboard and off board the vehicle 102, and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a vehicle key fob (not shown in FIG. 2), an external server, a user device, etc.), computers, and modules. The TCU 226 may be in communication with the ECUs 214 by way of a wired or wireless bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, and/or via wireless signal inputs received via the wireless connection(s) from other connected devices, such as the server 206, among others.

The BCM 220 generally includes integration of sensors, vehicle performance indicators, and variable reactors associated with vehicle systems and may include processor-based power distribution circuitry that may control functions associated with the vehicle body such as lights, windows, security, camera(s), audio system(s), speakers, wipers, door locks and access control, various comfort controls, etc. The BCM 220 may also operate as a gateway for bus and network interfaces to interact with remote ECUs (not shown in FIG. 2).

The DAT controller 228 and/or the autonomous driving system 240 may provide Level-1 through Level-5 automated driving and driver assistance functionality that may include, for example, active parking assistance, vehicle backup assistance, and/or adaptive cruise control, among other features. The DAT controller 228 may also provide aspects of user and environmental inputs usable for user authentication.

In some embodiments, the automotive computer 208 may connect with an infotainment system 238 (or a vehicle Human-Machine Interface (HMI)). The infotainment system 238 may include a touchscreen interface portion and may include voice recognition features, biometric identification capabilities that may identify users based on facial recognition, voice recognition, fingerprint identification, or other biological identification means. In other aspects, the infotainment system 238 may be further configured to receive user instructions via the touchscreen interface portion and/or output or display notifications, navigation maps, etc., on the touchscreen interface portion. In some embodiments, the user device 112 may provide the HMI interface.

The computing system architecture of the automotive computer 208 and/or the VCU 210 may omit certain computing modules. It should be readily understood that the computing environment depicted in FIG. 2 is an example of a possible implementation according to the present disclosure, and thus, it should not be considered as limiting or exclusive.

In addition to the components noted above, the vehicle 102 may have numerous mechanical systems and sub-systems. A chassis or frame may form the backbone of the vehicle 102 and support the body and other components of the vehicle 102. The vehicle 102 may include an engine that converts fuel into mechanical power, propelling the vehicle forward. The engine includes various components such as the engine block, pistons, valves, and spark plugs. The vehicle 102 may also include a transmission system. The transmission system transfers the engine's power to the wheels. It includes the clutch, gearbox, driveshaft, and differentials, among other components. The transmission adjusts the power output to suit the vehicle's speed and load. The vehicle 102 may also include a suspension system. The suspension system absorbs shocks and maintains contact between the tires and the road, providing a smooth ride. It includes components such as springs, shock absorbers, and linkages. The vehicle 102 also includes a vehicle-stopping system that allows the driver to slow down or stop the vehicle 102. It includes components like pedals, master cylinders, lines, and pads or shoes. The vehicle 102 also includes a steering system that enables the driver to guide the car. The steering system includes components such as the steering wheel, steering column, rack and pinion, and tie rods. The vehicle 102 may also include an exhaust system that removes and filters the waste gases produced by the engine. It includes the exhaust manifold, catalytic converter, muffler, and tailpipe, among other components. The vehicle 102 also includes a cooling system that prevents the engine and/or battery from overheating. It includes components such as the radiator, water pump, thermostat, and coolant. The vehicle 102 also includes a cooling system that stores and supplies fuel to the engine. It includes the fuel tank, fuel pump, fuel filter, and fuel injectors. An electrical system of the vehicle 102 powers the car's electrical components. It may include the battery, alternator, starter motor, and wiring. The Heating, Ventilation, and Air Conditioning (HVAC) system controls the temperature inside the vehicle 102. It includes the heater core, blower motor, and air conditioning compressor. In some embodiments, the vehicle may be an electric vehicle (EV) or hybrid vehicle, and in either case, some of the aforementioned components would be replaced by an electric motor and a high-voltage battery. All of the mechanical components working together ensure that the vehicle 102 operates optimally.

As mentioned above, CDNs are commonly used to serve content to end users. However, traditional CDNs use edge servers that are static and are often deployed at fixed locations, and serve a specific geographic area. If a user is far away from the edge server, the server's ability to reduce latency diminishes. This can lead to increased latency, as requests need to travel longer distances, especially in regions that are not well-covered by edge infrastructure. If the edge server is in a single location or a small set of locations, it may not be resilient to setbacks in certain regions. If there is an outage or traffic surge in that area, users may experience degraded service. In addition, static edge servers are fixed in terms of capacity. As demand increases, the edge server may become overloaded, leading to slower response times or even unavailability. Overloaded edge servers might take longer to process requests, leading to higher latency as resources become strained. High load can also result in server downtime or slowdowns, affecting service availability. During peak traffic, users may experience delays or errors in accessing the content.

Since the static edge servers are typically built with a fixed capacity, scaling these servers to meet new demand can be slow and costly. The server's performance may degrade as more users access it simultaneously, leading to traffic bottlenecks. If scalability is not properly managed, users may experience higher latency due to the overload on these servers. Limited scalability may lead to the server being unable to handle unexpected spikes in traffic, affecting its availability. In some instances, the server may also suffer from underutilization, where the server is over-provisioned for normal traffic but inefficiently handles peak times. In static edge server deployments, redundancy might not be well-designed. A single setback in the server or the underlying infrastructure (e.g., data center, power, or network issues) could affect the availability of services for users. Embodiments of the present disclosure provide systems and methods that can mitigate the above issues associated with traditional static edge server-based CDNs.

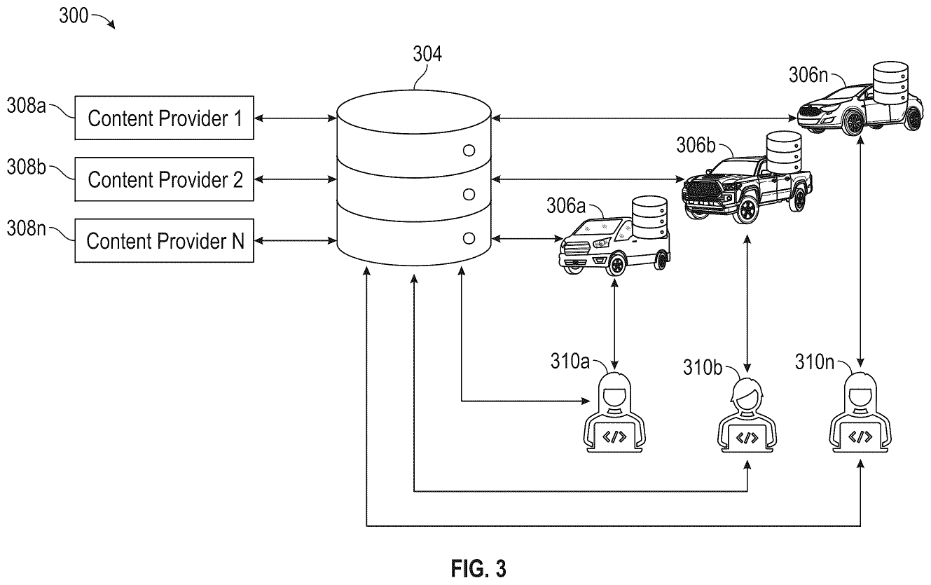

FIG. 3 illustrates a high-level functional diagram of a system 300 that can provide content delivery services according to an embodiment of the present disclosure. The system 300 may include a server 304, that can act as a central or control server that coordinates the content delivery services. In an embodiment, the server 103 described above can be programmed to perform the functions of the control server 304. The system 300 may also include one or more content provider servers 308a-308n. The content provider servers 308 can store media and other content generated by their respective content providers. The content provider servers 308 are communicably coupled with the control server 304 and can exchange control, configuration, and content data with the control server 304. The system 300 may also include one or more vehicles 306a-306n. In an embodiment, the vehicles 306 may be implemented using the vehicle 102 described above. The vehicles 306 are also communicably coupled with the control server 304 and can exchange control and configuration data with the control server 304. In addition, each of the vehicles 306 can receive content data from the control server 304.

The system 300 may also include one or more end-users 310a-310n. The end-users 310 are the consumers of the content provided by the content provider servers 308. Each end-user 310 may use a respective user device (for example, the user device 112 of FIG. 1). The user device used by each end-user 310 may be communicably coupled with one or more of the vehicles 306 and the control server 304 using any of the wireless or wired communication protocols mentioned above such as transmission control protocol/Internet protocol (TCP/IP), Bluetooth®, Bluetooth® Low Energy (BLE), Wi-Fi based on the Institute of Electrical and Electronics Engineers (IEEE) standard 802.11, Ultra-Wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In operation, an end-user 310 may send a request via his/her user device to the control server 304 to access a particular content item. The control server 304 may forward the request to one or more of the vehicles 306. If the vehicles 306 have the content stored in their memory, the vehicle 306, having the lowest latency to the use device of the requesting end-user 310, may provide the content to the user device associated with that end-user 310. In the instance that none of the vehicles 306 have the requested content stored in their memory, the vehicles 306 may inform the control server 304 accordingly. The control server 304 may then fetch the requested content item from the relevant content provider server 308. The control server 304 may then send that content item to the vehicle 306, that has the lowest latency to the user device of the requesting end-user 310. The end-user 310 may then connect his/her user device to the selected vehicle 306 and download the content item from the vehicle 306.

In order for the vehicle 306 to operate as an edge server, the vehicle 306 is equipped with the appropriate hardware and software that will enable the vehicle 306 to operate as an edge server. Studies have shown that vehicles are either parked or otherwise idle (i.e., not moving) for >90% of their usable lifetime. The two most recurring locations where a vehicle may be parked for extended periods are the home and the office of a user. When the vehicle is parked or otherwise idle, the vehicle may be configured to operate as an edge server to implement the embodiments of the present disclosure. In some embodiments, the user of the vehicle may be incentivized, monetarily or otherwise, to allow his/her vehicle to be used as an edge server when the vehicle is parked or otherwise idle. The user of the vehicle can have the option of choosing whether to allow his/her vehicle to act as an edge server during these parked or otherwise idle time periods. Most modern vehicles have several functions that can be controlled or operated using a user device such as a mobile phone. For example, it is common to have an application installed on the mobile phone of the user that can be used to control aspects of the vehicle.

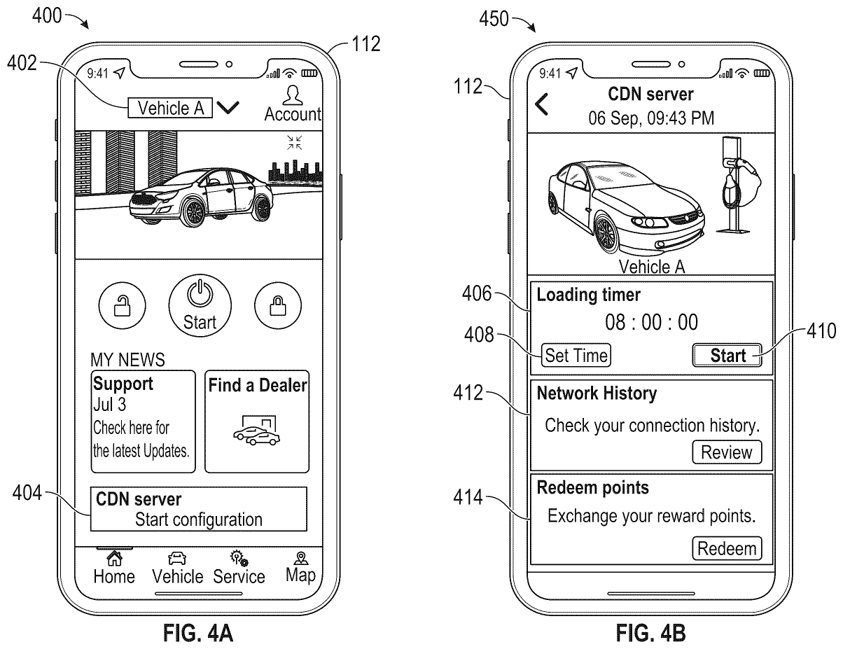

FIGS. 4A and 4B illustrate user interface screens of the user device 112 according to an embodiment of the present disclosure. User interface screen 400 may depict a home screen of an application that can be used to control aspects of the vehicle. As illustrated in the user interface screen 400, the application may display information about the vehicle 402. The information 402 may include the make, model, VIN, etc. of the vehicle. Among other control icons and information presented on the user interface screen 402, the user interface screen 402 may include a selectable icon related to enabling and configuring a CDN edge server mode for the vehicle. A user of the vehicle may activate the selection 404 to enable and configure the CDN edge server mode of the vehicle. User interface screen 450 illustrates an example of the configuration parameters that may be available for the user of the vehicle to configure and enable the CDN server mode. As illustrated in the user interface screen 450, there may be a timer section 406, network history section 412, and a rewards information section 414. In the timer section 406, the user may have an option to set a time duration for which the vehicle may operate as a CDN server. For example, if the user is usually at work between 9:00 AM and 5:00 PM and the vehicle is parked during those times, the user may use the “set time” function 408 to configure the vehicle to operate as a CDN server during those times. In some embodiments, when particular time periods are associated with recurring instances of the vehicle being parked or otherwise idle, the set time function 408 may be used to set recurring instances of when the vehicle may operate as a CDN server. In this manner, the user can set up time-slots in advance of when the vehicle can be operated as a CDN server, greatly simplifying the user experience. In certain instances, the vehicle's geo-location information may be used to enable/disable the CDN server mode. Continuing the above example, in addition to the time, the vehicle's geo-location may be used to determine whether the vehicle is at the user's work location. So, in the instance that the user parks the vehicle at a different location during the 9 AM-5 PM time period on any given day, the CDN edge server mode may not be automatically enabled, and the user may be provided a notification to ask the user whether he/she would like to enable the CDN edge server mode. In an embodiment, the timer section 406 may be “grayed out” or otherwise made unavailable for selection when the vehicle is in motion. Thus, a user of the vehicle cannot enable the CDN edge server mode while the vehicle is in motion.

The timer section 406 may also be used to enable ad-hoc activation of the CDN edge server mode by the user of the vehicle. In an instance where the user is going to be busy for a period of time at an event, but that period of time is not recurring (for example, the user is going to watch a movie), the user can dynamically enable the CDN server mode by activating the “start”410 icon/button after the user has parked the vehicle. After the user activates the start 410 icon/button, the CDN server mode of the vehicle is enabled. When the user returns to the vehicle after the event, the user can activate a “stop” icon/button (not shown) to disable the CDN server mode. In this manner, the user of the vehicle has full control over when to enable and disable the CDN server mode of the vehicle. One skilled in the art will realize that the icons and information shown on the user interface screens 400 and 450 are exemplary, and other types of information and control selections may be used to achieve the functionality described above. All such other mechanisms of achieving the functions described above are within the scope of this disclosure.

In some embodiments, once a CDN edge server mode on a vehicle is enabled, the vehicle may send that information and its geo-location information to a CDN control server (for example, control server 304 of FIG. 3). The CDN control server thus may have a running list of all vehicles in a particular geographic area that are currently operable as a CDN edge server. The list may be updated continually as the CDN edge server mode on the vehicles in the geographic area is enabled or disabled. The CDN control server has the most updated list of vehicles that currently have their CDN edge server mode enabled and their current location. This helps the control server in selecting the appropriate vehicle to serve the content to the requesting user. The vehicles may also send their current network information to the CDN control server. The network information may include bandwidth, type of network protocol being used by the vehicle, memory capacity of the vehicle, latency, and other network-related information. The vehicles may also send a list of content items currently stored in the vehicle memory and a remaining free memory capacity information to the CDN control server.

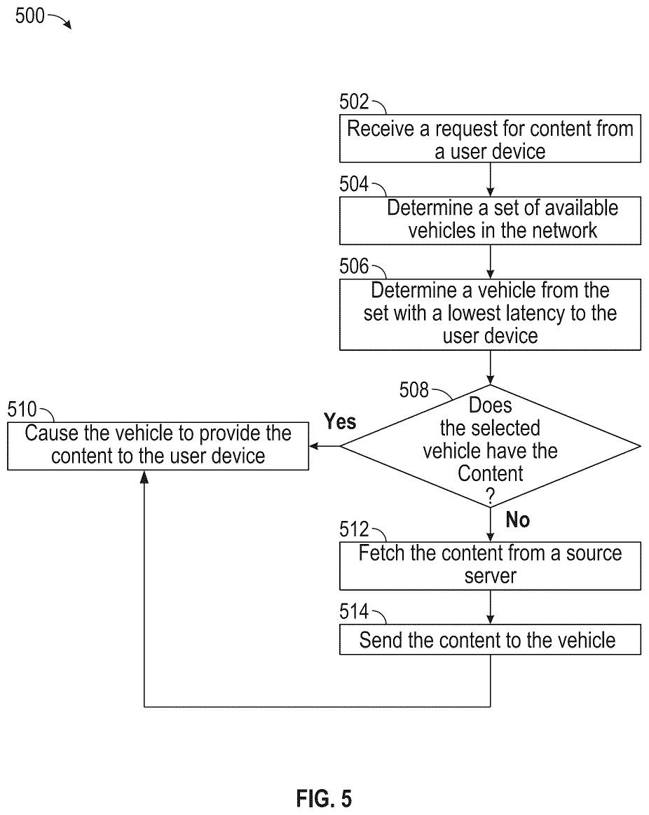

FIG. 5 illustrates a flow chart for a process 500 for providing content to one or more end users according to an embodiment of the present disclosure. Process 500 can be performed, for example, by the control server 104, or the control server 304, and/or the vehicle 102 described above. At step 502, the server may receive a request from a user device. The request may include information about a content item requested by the user. For example, the request may be in the form of universal resource locator (URL) data, a Hypertext Transfer Protocol (HTTP) message, or the like that indicates some identifying information about the content item. After receiving the request, the control server may parse the information to determine which content item is being requested. Then, at step 504, the control server may determine a set of available vehicles in a network that includes the control server. For example, the control server may be part of a content delivery network that includes multiple vehicles that are registered with and communicably coupled with the control server. Further, in this instance, available vehicles mean that the vehicles are parked or otherwise idle, and their respective CDN edge server mode has been enabled. In other words, available vehicles include vehicles that are ready to operate as a CDN edge server. It is to be understood that not all vehicles in the network may be currently available. As described above, once a particular vehicle is parked or otherwise idle, and the CDN edge server mode of that vehicle is enabled, the vehicle may inform the control server of its current status and geographic location. Also, the user device may send its geographic location information to the control server along with the initial request for the content item. Thus, the control server knows the location of the vehicles as well as that of the user device that is requesting the content.

Once the control server determines which vehicle(s) are currently available to operate as a CDN edge server, the control server may then determine which vehicle(s) has a lowest latency to the user device at step 506. In an embodiment, each of the vehicles may report its respective latency parameter with respect to the user device to the central server by performing a ping test with the user device. In other embodiments, the control server may instruct the vehicle to perform a latency test and report that parameter to the control server. Latency between two devices may be affected by several factors, such as propagation delay, transmission delay, processing delay at either of the devices, queuing delay, packet loss and retransmission, protocol overhead, network topology, network type, application-specific factors, interference, latency jitter, firewall and security filters, DNS resolution, operating system, physical distance between the vehicle and the user device, and the like. In some instances, the control server may determine a plurality of vehicles that have a latency value that is lower than a threshold value such that any of these vehicles may effectively serve as a CDN edge server. Further, having multiple vehicles that can serve as the CDN edge server builds in redundancy in the event that one or more of the vehicles can no longer serve as a CDN server during a communication session (for example, a user of a vehicle disables the CDN edge server mode in the middle of content transmission). In an embodiment, the control server may generate a list of available devices ranked in the order of their latency to the user device.

After the control server identifies one or more vehicles in the network that are available to server as a CDN edge server, the control server may then determine whether any of the determined vehicles has the content items stored in its memory, at step 508. In one instance, the control server may start with the vehicle having the lowest latency to the user device and work its way through the list of available vehicles in increasing order to latency to the user device. If the control server determines that at least one vehicle from the list of available vehicles includes the content item stored in its local memory, the control server may instruct that vehicle to provide the content item to the user device at step 510. If the control server determines, at step 508, that none of the selected vehicles have the content item stored in their local memory, the control server may fetch the content item from the source server associated with the content item at step 512. In some instances, the source server may be the server operated by the content item generator/provider.

Upon receiving the content item from the source server, the control server may send the content item to one of the determined vehicles in the list—preferably to the vehicle having the lowest latency to the user device, at step 514. Thereafter the content server may cause the vehicle to send the content item to the user device at step 516. This could be in the form of an instruction to the vehicle to send the content item to the user device. The vehicle may then communicate with the user device and provide that content item to the user device.

In some instances, vehicles in the closest proximity of the user device may not be enabled to operate as a CDN edge server. In other words, there may be no vehicles available that are in the closest proximity of the user device. Preferably we would want the user device to get content from a vehicle that is closest in proximity to the user device since that vehicle is likely to have the lowest latency to the user device. Physical proximity between devices greatly affects latency, especially when using a wireless communication medium. However, it may still be possible to fulfill user requests using vehicles that may be located farther away from the user device, depending on the nature of the content requested and associated network conditions. Thus, it may be beneficial in some instances to fulfill user requests even if the quality of service is lower than a threshold.

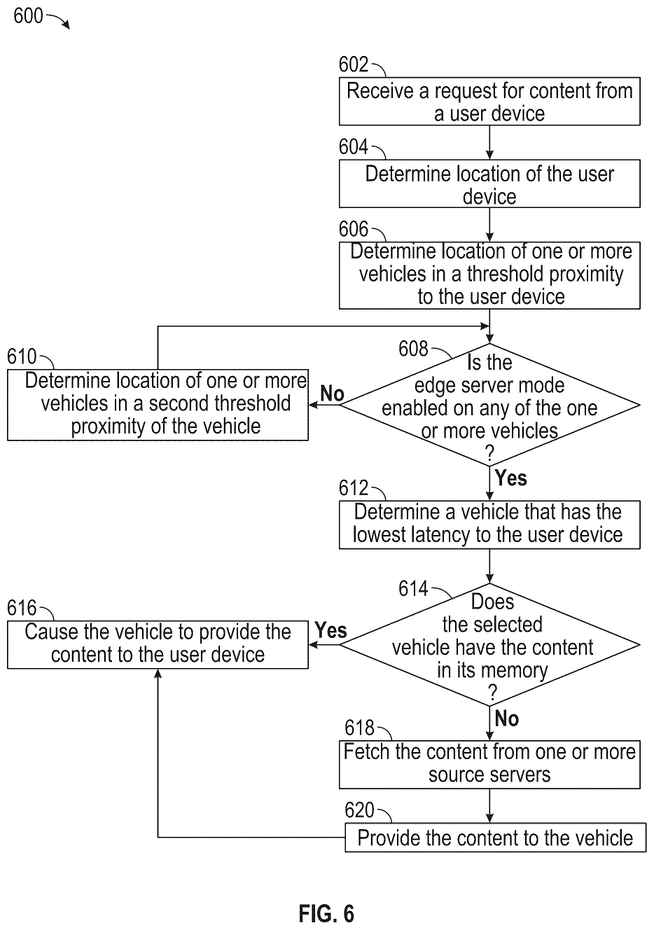

FIG. 6 illustrates a flow chart of a process 600 for providing content to a user device according to an embodiment of the present disclosure. The process 600 may be performed by the control server 104 and/or the vehicle 102 of FIG. 1, or the control server 304 of FIG. 3. At step 602, the control server may receive a request from a user device for a content item. The content item may include a web page, multimedia content, interactive content, software and downloads, web services and APIs, live data feeds, online communications, virtual reality (VR)/augmented reality (AR) content, virtual goods, or the like. At step 604, the control server may determine a location of the user device. In an instance, the user device may send its current location information as part of the request at step 602. At step 606, the control server may determine one or more vehicles that is with a first threshold proximity of the user device. The first threshold proximity may be a programmed by the operator of the control server and may be based on historical network data at the location and/or historical demand for content at that location. For example, the first threshold proximity can be set at 100 meters.

After the control server determines the one or more vehicles that are currently within the first threshold proximity of the user device, the control server may then determine whether the CDN edge server mode is enabled on any of the one or more vehicles, at step 608. As noted above, for the CDN edge server mode to be enabled, the vehicle should be preferably parked or otherwise idle. If the control server determines that none of the vehicles within the first threshold proximity of the user device have their CDN edge server mode enabled, the control server may determine one or more vehicles within a second threshold proximity of the user device, at step 610. For example, the second threshold proximity may be set at 200 meters. The process may return to step 608 where the control server may check whether any vehicle that is within the second threshold proximity of the user device has its CDN server mode enabled. In some instances, the control server may iterate between steps 608 and 610 until it finds a vehicle whose CDN edge server mode is enabled. In other instances, the control server may not be able to determine any vehicle that is enabled to operate as a CDN edge server. In that instance, the control server may end the process 600 and provide a notification to the user that the request cannot be fulfilled.

If at step 608, the control server determines that multiple vehicles in the vicinity of the user device are currently enabled to operate as a CDN edge server, the control server then determines a vehicle having a lowest latency to the user device, at step 612. Thereafter, the control server may determine whether the determined vehicle has the requested content stored in its local memory, at step 614. If the vehicle has the content stored in its local memory, the control server may instruct the vehicle to provide the content to the user device at step 616. If at step 614, it is determined that the vehicle does not have the requested content, the control server may fetch that content from a source server at step 618. Thereafter, at step 620, the control server may send the content to the vehicle, and the vehicle may then send the content to the user device (step 616).

In an alternate embodiment, if the control server determines at step 614 that the selected vehicle having the lowest latency does not have the content stored in its local memory, the control server may determine whether a second vehicle, that has a higher latency than the selected vehicle, has the content item stored in its memory and if so, may instruct the second vehicle to send the content to the user device. In some instances, instructing the vehicle having a slightly higher latency to send the content from its local memory may be faster than fetching the content from the source server (step 618). This may reduce the overall time it takes to serve the requested content to the user device. Thus, the control server may balance between fetching the content from the source server or instructing a different vehicle to serve the content, even if the latency of the different vehicle is higher than that of the initially chosen vehicle.

In other instances, the control server may select a vehicle to serve content to a user device, but the user of that vehicle may disable the CDN edge server mode while the content is being sent to the user device. This can happen in the case of streaming content when the total duration during which the content is being provided to the user device may last between several minutes to several hours (for example, when streaming a movie or a live sporting event). In such an instance, the server may identify several vehicles in the proximity of the user device that may operate as a CDN edge server. In the event that the initially chosen vehicle becomes unavailable, the control server may instruct another vehicle to take over the task of providing the content to the user device. Thus, the user experiences minimal glitches in his/her viewing experience.

In some instances, embodiments of the present disclosure may be used to provide on-demand edge server functionality for a specific event or location based on expected and/or actual demand. For example, there may be an increased demand for content delivery services due to an event being held at a particular location. In such an instance, the vehicle-based edge servers can be deployed at such locations and in the vicinity of such locations to enhance the existing edge server or network capability for the duration of the event. Specifically, autonomous vehicles can be deployed in this instance to provide added bandwidth due to the higher-than-normal expected user demand.

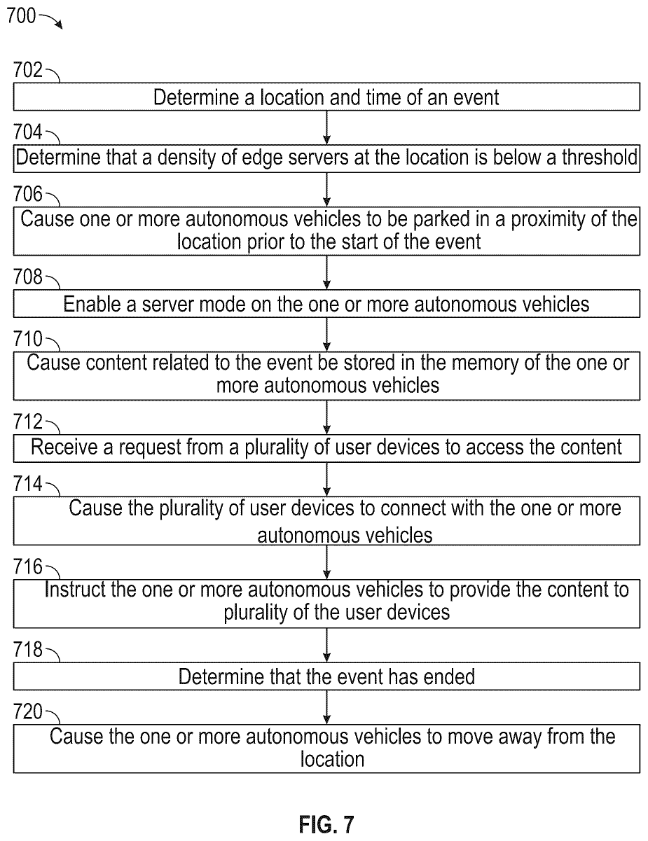

FIG. 7 illustrates a flow chart of a process 700 according to an embodiment of the present disclosure. The process 700 may be performed by the control server 104 and/or the vehicle 102 of FIG. 1, or the control server 304 of FIG. 3. At step 702, the control server may determine a location and a time of an event being held at the location. This information may be obtained from several sources, including news channels, online advertising of the event, local event calendar, etc. Based on the occurrence of the event, the control server may determine that there will be an increased need for network and content delivery services during the event. At step 704, the control server may determine that the existing density of edge servers in and around that location is below a threshold. The control server may obtain this data from public sources that may store this information, a database maintained by the local government or any other entity, etc.

Based on determining that the current density of edge servers at or around the location is less than the threshold, the control server may cause one or more autonomous vehicles to travel and be parked at designated parking spots in the vicinity of the location (step 706). Once the autonomous vehicles are parked, the control server may remotely enable the CDN edge server mode for the autonomous vehicles and prepare them for providing content delivery services (step 708). Once the event begins, the control server may cause the autonomous vehicles to store content related to the event in the local memory of the respective autonomous vehicles (step 710). The content may be continually refreshed to include the most recent content related to the event. The type and amount of content to be stored in the local memory of the autonomous vehicles may depend on several factors, such as expected demand from end-users, type of content expected to be requested, amount of content expected to be requested, etc. At step 712, the control server may receive multiple requests from multiple users to access the content related to the event. Since the autonomous vehicles already have the content stored in their local memory, the control server can instruct the autonomous vehicles to provide the content to the user devices in response to receiving the requests.

At step 714, the control server may cause each of the plurality of user devices to be connected to one of the autonomous vehicles. For example, in response to the request received from the user device, the control server may send a network address associated with one of the autonomous vehicles to the user device for the user device to be able to connect with the autonomous vehicle. In an instance, the selection of the autonomous vehicle to connect with a particular user device can be made using the techniques described above. Once connected, the control server may then instruct the autonomous vehicle to provide the requested content to the user device at step 716. At step 718, the control server may determine that the event has ended and the added network capacity is no longer needed. In response to this determination, the control server may disable the CDN edge server mode on the autonomous vehicles and instruct the autonomous vehicles to move away from their respective locations (step 720). In an embodiment, the autonomous vehicles may be instructed to return back to their home location.

FIG. 8 depicts a block diagram of an example control server 800 (e.g., control server 104 of FIG. 1) upon which any of one or more techniques (e.g., methods) may be performed or which may perform the methods described above in conjunction with the vehicle 102, in accordance with one or more example embodiments of the present disclosure. In other embodiments, the server 800 may operate as a standalone device or may be connected (e.g., networked) to other servers. In a networked deployment, the server 800 may operate in the capacity of a server machine, a client machine, or both in server-client network environments. In an example, the server 800 may act as a peer server in peer-to-peer (P2P) (or other distributed) network environments. The server 800 may be a personal computer (PC), a tablet PC, a set-top box (STB), a personal digital assistant (PDA), a mobile telephone, a smart key fob, a wearable computer device, a web appliance, a network router, a switch or bridge, or any machine capable of executing instructions (sequential or otherwise) that specify actions to be taken by that server, such as a base station. Further, while only a single server is illustrated, the term “server” shall also be taken to include any collection of servers that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific task when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The server (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The server 800 may further include a graphics display device 810, an alphanumeric input device 812 (e.g., a keyboard), and a user interface (UI) navigation device 814 (e.g., a mouse). In an example, the graphics display device 810, alphanumeric input device 812, and UI navigation device 814 may be a touch screen display. The server 800 may additionally include a storage device (i.e., drive unit) 816, a network interface device/transceiver 820 coupled to antenna(s), and one or more sensors 828, such as a global positioning system (GPS) sensor, a compass, an accelerometer, or another sensor. The server 800 may include an output controller 834, such as a serial (e.g., universal serial bus (USB)), parallel, or other wired or wireless (e.g., infrared (IR)), near field communication (NFC), etc. connection to communicate with or control one or more peripheral devices (e.g., a printer, a card reader, etc.).

The storage device 816 may include a machine-readable medium 822 on which is stored one or more sets of data structures or instructions (e.g., software) embodying or utilized by any one or more of the techniques or functions described herein. The instructions may also reside, completely or at least partially, within the main memory 804, within the static memory 806, or within the hardware processor 802 during execution thereof by the server 800. In an example, one or any combination of the hardware processor 802, the main memory 804, the static memory 806, or the storage device 816 may constitute machine-readable media.

While the machine-readable medium 822 is illustrated as a single medium, the term “machine-readable medium” may include a single medium or multiple media (e.g., a centralized or distributed database and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; a flash memory, etc.

The term “machine-readable medium” may include any medium that is capable of storing, encoding, or carrying instructions for execution by the server 800 and that causes the server 800 to perform any one or more of the techniques of the present disclosure or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver 820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMAXs®), IEEE 802.15.4 family of standards, and peer-to-peer (P2P) networks, among others. In an example, the network interface device/transceiver 820 may include one or more physical jacks (e.g., Ethernet, coaxial, or phone jacks) or one or more antennas to connect to the communications network. In an example, the network interface device/transceiver 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the server 800 and includes digital or analog communications signals or other intangible media to facilitate communication of such software. The operations and processes described and shown above may be carried out or performed in any suitable order as desired in various implementations. Additionally, with certain implementations, at least a portion of the operations may be carried out in parallel. Furthermore, in certain implementations, less than or more than the operations described may be performed.

It is to be noted that the vehicle implements and/or performs operations, as described here in the present disclosure, in accordance with the owner manual and safety guidelines. In addition, any action taken by the vehicle owner/driver based on recommendations or notifications provided by the vehicle should comply with all the rules specific to the location and operation of the vehicle (e.g., Federal, state, country, city, etc.). The recommendations or notifications, as provided by the vehicle, should be treated as suggestions and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more hardware, software, firmware, digital components, or analog components. For example, one or more application-specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name but not function.

It should also be understood that the word “example,” as used herein, is intended to be non-exclusionary and non-limiting in nature. More particularly, the word “example,” as used herein, indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices, such as those listed above, and stored on a computer-readable medium.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving, by a server, a request from a user device, the request including information about a content item;
determining, by the server, a first location of the user device;
determining, by the server, at a first time, one or more vehicles located in a vicinity of the first location;
determining, by the server, that the one or more vehicles are currently parked;
determining, by the server, that an edge server mode is enabled on the one or more vehicles;
determining, by the server, a first vehicle from the one or more vehicles that has a lowest latency to the user device; and
instructing, by the server, the first vehicle to provide the content item to the user device.

2. The method of claim 1, wherein prior to the instructing, determining, by the server, that the first vehicle has the content item stored in a local memory of the first vehicle.

3. The method of claim 1, wherein prior to the instructing:
determining, by the server, that the first vehicle does not have the content item stored in a local memory of the first vehicle;
fetching, by the server, the content item from a source server; and
providing, by the server, the content item to the first vehicle.

4. The method of claim 1, further comprising:
determining, by the server at a second time after the first time, that the edge server mode on a first plurality of vehicles parked within a first threshold proximity of the user device is disabled;
determining, by the server, a second plurality of vehicles parked within a second threshold proximity of the user device, the second threshold proximity being higher than the first threshold proximity; and
determining, by the server, that the edge server mode is enabled on one or more of the second plurality of vehicles.

5. The method of claim 4, further comprising: instructing, by the server, one of the one or more of the second plurality of vehicles to provide the content item to the user device.

6. The method of claim 1, wherein determining that the edge server mode is enabled on the one or more vehicles, includes receiving a message from the one or more vehicles indicating a current status of the edge server mode of the respective vehicle.

7. The method of claim 1, further comprising:
receiving, by the server, information from the first vehicle that the edge server mode of the first vehicle is disabled;
determining, by the server, a second vehicle, from the one or more vehicles, that has the next lowest latency to the user device; and
instructing, by the server, the second vehicle to provide the content item to the user device.

8. The method of claim 1, further comprising:
receiving, by the server from each of the one or more vehicles, a current location information of each of the one or more vehicles; and
receiving, by the server from each of the one or more vehicles, a current motion state information of each of the one or more vehicles.

9. A control server comprising:
one or more processors;
a memory device coupled to the one or more processors; and
a communication interface coupled to the one or more processors, wherein the memory device stores instructions that, when executed by the one or more processors, cause the one or more processors to:
receive a request from a user device, the request including information about a content item;
determine a first location of the user device;
determine, at a first time, one or more vehicles located in a vicinity of the first location;
determine that the one or more vehicles are currently stationary;
determine that an edge server mode is enabled on the one or more vehicles;
determine, a first vehicle, from the one or more vehicles, that has a lowest latency to the user device; and
instruct the first vehicle to provide the content item to the user device.

10. The control server of claim 9, wherein the instructions further cause the one or more processors to:
receive, from each of the one or more vehicles, a current location information of each of the one or more vehicles; and
receive, from each of the one or more vehicles, a current motion state information of each of the one or more vehicles.

11. The control server of claim 9, wherein the instructions further cause the one or more processors to:
receive information from the first vehicle that the edge server mode of the first vehicle is disabled;
determine a second vehicle, from the one or more vehicles, that has the next lowest latency to the user device; and
instruct the second vehicle to provide the content item to the user device.

12. The control server of claim 9, wherein the instructions further cause the one or more processors to:
determine, at a second time after the first time, that the edge server mode on a first plurality of vehicles parked within a first threshold proximity of the user device is disabled;
determine a second plurality of vehicles parked within a second threshold proximity of the user device, the second threshold proximity being higher than the first threshold proximity; and
determine that the edge server mode is enabled on one or more of the second plurality of vehicles.

13. The control server of claim 12, wherein the instructions further cause the one or more processors to:
instruct one of the one or more of the second plurality of vehicles to provide the content item to the user device.

14. The control server of claim 9, wherein to determine that the edge server mode is enabled on the one or more vehicles, the instructions further cause the one or more processors to receive a message from the one or more vehicles indicating a current status of the edge server mode of each of the one or more vehicles.

15. The control server of claim 9, wherein prior to instructing the first vehicle to provide the content item to the user device, the instructions further cause the one or more processors to:
determine that the first vehicle does not have the content item stored in a local memory of the first vehicle;
fetch the content item from a source server; and
provide the content item to the first vehicle.

16. The control server of claim 9, wherein prior to instructing the first vehicle to provide the content item to the user device, the instructions further cause the one or more processors to:
determine that the first vehicle has the content item stored in a local memory of the first vehicle.

17. A method comprising:
determining a location and time of an event;
determining that a density of edge servers at the location is lower than a threshold;
causing a plurality of autonomous vehicles to travel to the location and park in a vicinity of the location;
enabling an edge server mode on each of the plurality of autonomous vehicles;
causing content related to the event to be stored in a local memory of each of the plurality of autonomous vehicles;
receiving requests from a plurality of user devices to access the content related to the event; and
causing the plurality of autonomous vehicles to provide the content related to the event to the plurality of user devices.

18. The method of claim 17, further comprising:
determining that the event has finished; and
causing the plurality of autonomous vehicles to leave the vicinity of the location.

19. The method of claim 17, further comprising:
causing each of the plurality of user devices to communicably couple with at least one vehicle from the plurality of autonomous vehicles.

20. The method of claim 17, further comprising receiving the content related to the event from a source server.
